(19) United States
(12) Patent Application Publication
(10) Pub. No.: US 2022/0317993 A1
(43) Pub. Date: Oct. 6, 2022

(54) VEHICLE PROGRAM UPDATE DEVICE, VEHICLE, VEHICLE INFORMATION MANAGEMENT SERVER, AND PROGRAM UPDATE METHOD

(71) Applicant: HONDA MOTOR CO., LTD., Tokyo (JP)

(72) Inventor: Tomoaki Taki, Tokyo (JP)

(21) Appl. No.: 17/675,682

(22) Filed: Feb. 18, 2022

(30) Foreign Application Priority Data
Mar. 30, 2021 (JP) 2021-056718

(51) Int. Cl. G06F 8/65; G06F 8/71; B60W 50/14

(52) U.S. Cl. CPC G06F 8/65; G06F 8/71; B60W 50/14; B60W 2050/146

(57) ABSTRACT

A vehicle program update device including a processor that acquires a program from a distribution server through wireless communication means, performs writing processing of the program acquired into the vehicle control unit, acquires flag information indicating whether at least one predetermined function of the vehicle is in a usable state, the function being included in the program, from the program processed, writes the flag information into the program so that the flag information indicates the usable state or a state of function restriction based on instruction information, and transmits, to a vehicle information management server, version information about the program installed into and at least one piece of the flag information included in the program, wherein the vehicle executes the predetermined function which is indicated as usable in the flag information.

### INCORPORATION BY REFERENCE

The present application claims priority under 35 U.S.C. § 119 to Japanese Patent Application No. 2021-056718 filed on Mar. 30, 2021. The content of the application is incorporated herein by reference in its entirety

### BACKGROUND OF THE INVENTION

### Field of the Invention

The present invention relates to a vehicle program update device that updates and manages a program for a control device mounted on a vehicle, a vehicle information management server, and a program update method.

### Description of the Related Art

In recent years, a movement to make vehicles “connected” is progressing in which a vehicle is connected to a network utilizing a wireless technology. In such “connected” vehicles, comfortable operation such as autonomous driving is expected in the future, whereas a security risk in which a vehicle is attacked through a network is increasing. Many control devices are used for a current vehicle, and programs (software) for controlling the control devices (ECUs) require updates involving addition or correction of functions. Since the update management for the programs is directly related to the user's safety, the update management is to be subjected to the regulation by the laws based on the international standards. In the regulation, thorough update management for the programs is required.

As for a computer that is connected to a maintenance apparatus to perform update work, the maintenance apparatus being connected to a vehicle to update a program, Japanese Patent Laid-Open No. 2014-48800 discloses an authentication system to allow only an authenticated computer to update a program. However, in the case where in normal operation, program update is performed for the control device mounted on the vehicle using wireless communication means, specifically, using an over the air (OTA) technology, there occurs a difference in program update history for a plurality of control devices of each vehicle, and therefore it is necessary not only to prevent illegal use but also to manage program update for each vehicle. A program for the control unit mounted on the vehicle is not permitted to be downgraded from the view point of security, and therefore, if a new function is added once, the program cannot be returned to the previous version, which makes it impossible to flexibly add or eliminate the function. In the case where a developer communicates with a plurality of different ECUs to perform integrated control, it is difficult to establish matching among the programs to be executed by the plurality of ECUs as circumstances vary depending on the vehicle, when a program initially distributed is updated to a new program to improve a function.

The present invention is made in the light of the above-described background, and has an object to provide a vehicle program update device that flexibly manages function addition and function restriction for a plurality of control devices mounted on a vehicle, a vehicle, a vehicle information management server, and a program update method.

### SUMMARY OF THE INVENTION

An inventive aspect to achieve the object described above provides a vehicle program update device including a program acquisition unit configured to acquire a program to be installed into a vehicle control unit mounted on a vehicle from a distribution server through wireless communication means, a program writing unit configured to perform writing processing of the program acquired by the program acquisition unit into the vehicle control unit, a flag information acquisition unit configured to acquire flag information indicating whether at least one predetermined function of the vehicle is in a usable state, the function being included in the program, from the program processed by the program writing unit, a flag information writing unit configured to write the flag information into the program so that the flag information indicates the usable state or a state of function restriction based on instruction information, and a transmission unit configured to transmit, to a vehicle information management server, version information about the program installed into the vehicle control unit and at least one piece of the flag information included in the program, wherein the vehicle executes the predetermined function which is indicated as usable in the flag information.

The above-described program update device may have a configuration in which the transmission unit transmits, to the vehicle information management server, function restriction information which is information about the predetermined function in the state of the function restriction, the predetermined function being included in the program installed into the vehicle control unit.

The above-described program update device may have a configuration in which the instruction information is generated based on a fact that execution of the predetermined function for the vehicle has been approved by a manager of the vehicle, and the flag information writing unit writes the flag information into the program based on the instruction information.

The above-described program update device may have a configuration in which the instruction information is generated based on a fact that billing processing for the predetermined function has been completed by a manager of the vehicle, and the flag information writing unit writes the flag information into the program based on the instruction information.

The above-described program update device may have a configuration in which a flag information generation unit is further provided to generate the flag information for bringing a predetermined first function into the state of the function restriction after an elapse of a first usable period in a case where the first function is permitted to be in the usable state during the first usable period.

A second inventive aspect to achieve the object described above provides a vehicle on which the vehicle program update device according to any one of the above-described first aspects is mounted.

A third inventive aspect to achieve the object described above provides a vehicle information management server that manages a vehicle, the server including a flag information management unit configured to manage flag information indicating that at least one predetermined function of the vehicle is in a usable state, among functions included in a program for a vehicle control unit, with respect to a vehicle program update device that acquires and manages the program to be installed into the vehicle control unit mounted on the vehicle through wireless communication means.

The above-described vehicle information management server may have a configuration in which the flag information management unit manages the flag information based on a fact that execution of the predetermined function for the vehicle has been approved by a manager of the vehicle.

The above-described vehicle information management server may have a configuration in which the flag information management unit generates the flag information for bringing a predetermined second function into the state of the function restriction after an elapse of a predetermined second usable period in a case where the second function is permitted to be in the usable state during the second usable period.

A fourth inventive aspect to achieve the object described above provides a program update method including a program acquisition step of acquiring a program to be installed into a vehicle control unit mounted on a vehicle from a distribution server through wireless communication means, a program writing step of performing writing processing of the program acquired in the program acquisition step into the vehicle control unit, a flag information acquisition step of acquiring flag information indicating whether at least one predetermined function of the vehicle is in a usable state, the function being included in the program, from the program processed in the program writing step, a flag information writing step of writing the flag information into the program so that the flag information indicates the usable state or a state of function restriction based on instruction information, and a transmission step of transmitting, to a vehicle information management server, version information about the program installed into the vehicle control unit and at least one piece of the flag information included in the program, wherein the vehicle executes the predetermined function which is indicated as usable in the flag information.

The above-described program update method may have a configuration in which the flag information acquisition step acquires the flag information generated based on a fact that execution of the predetermined function for the vehicle has been approved by a manager of the vehicle.

According to the above-described vehicle program update device, vehicle, vehicle information management server, and program update method, a function implemented by the control device for controlling the apparatus mounted on the vehicle is switchable between the state of the function restriction and the usable state. This produces an advantageous effect that the function can be flexibly added or eliminated within a scope of regulation by the laws for program update and management.

### BRIEF DESCRIPTION OF THE DRAWINGS

FIG. 1 is a diagram illustrating a vehicle program management system;

FIG. 2 is a configuration diagram including a vehicle information management server and a vehicle control unit;

FIG. 3 is a functional block diagram illustrating a vehicle program update device;

FIG. 4 is a functional block diagram illustrating a vehicle information management server;

FIG. 5 is a flowchart illustrating operations to write a program for each ECU and write flag information by the vehicle program update device;

FIG. 6 is a flowchart of a flag information generation operation in the vehicle program update device;

FIG. 7 is a table illustrating an example of correspondence between a function change and flag information based on billing or the like;

FIG. 8 is a flowchart illustrating an operation of changing a function based on approval information and accounting information of a vehicle manager; and

FIG. 9 is a flowchart illustrating operations for changing a function by the vehicle information management server.

### DETAILED DESCRIPTION OF THE PREFERRED EMBODIMENTS

Hereinafter, embodiments will be described in detail with reference to the drawings. However, the detailed description more than necessary may be omitted. For example, detailed description of well-known matters and redundant description on substantially the same configuration may be omitted. This is to avoid an unnecessary redundancy in the following description and to facilitate understanding by those skilled in the art.

Note that the accompanying drawings and the following description are provided to enable those skilled in the art to fully understand the present disclosure and are not intended to limit subject matters of claims.

### 1-1. Configurations of Vehicle Program Update Device and Vehicle Information Management Server According to First Embodiment

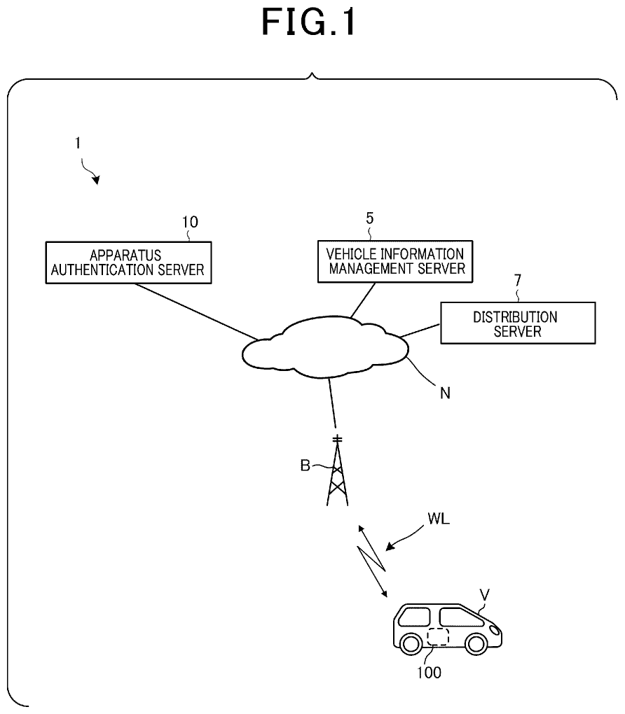

FIG. 1 is a diagram illustrating a vehicle program management system 1 in a vehicle V. In the case where the vehicle V supports program update through wireless communication means WL and a function change in a control device, that is, in the case where a program can be updated and a function can be changed in a vehicle control device 100 through over the air (OTA), service is provided from a vehicle information management server 5 or a distribution server 7 to the vehicle V.

Specifically, an update program is distributed from the distribution server 7 to the vehicle V through a network N and a base station B. Information about a function change is distributed from the vehicle information management server 5 to the vehicle V through the network N and the base station B. At this time, only the vehicle V and vehicle control device 100 that are authenticated by an apparatus authentication server 10 are managed to support the program update and the function change. An update history of the program is managed by, for example, the vehicle information management server 5, in association with a vehicle identification number of the vehicle V.

As used herein, the term “vehicle” is referred to as a moving body such as an automobile or a motorcycle. The moving body may have a drive train including an internal combustion engine using a combustible fuel or may be driven by the other energy sources such as electric energy stored in a battery and hydrogen energy.

The vehicle program management system 1 including the vehicle information management server 5 according to the present embodiment is a vehicle program management system that performs update management for a plurality of programs stored in and executed by each of a plurality of vehicle control units mounted on the vehicle V, the vehicle program management system 1 including the vehicle information management server 5 configured to manage a program configuration which is a combination of the plurality of programs, the distribution server 7 configured to distribute the programs, and the apparatus authentication server 10 configured to authenticate the vehicle and the vehicle control units. Each of the vehicle information management server 5, the distribution server 7, and the apparatus authentication server 10 is an information processing device that processes information, provides information, and stores information, and specifically, may be a computer. The vehicle information management server 5, the distribution server 7, the apparatus authentication server 10, the vehicle control device 100 exchange information with one another through the network N. Each of the vehicle information management server 5, the distribution server 7, and the apparatus authentication server 10 is comprised of a computer. Each of the vehicle information management server 5, the distribution server 7, and the apparatus authentication server 10 implements its function by causing the computer to execute software (program) installed into itself.

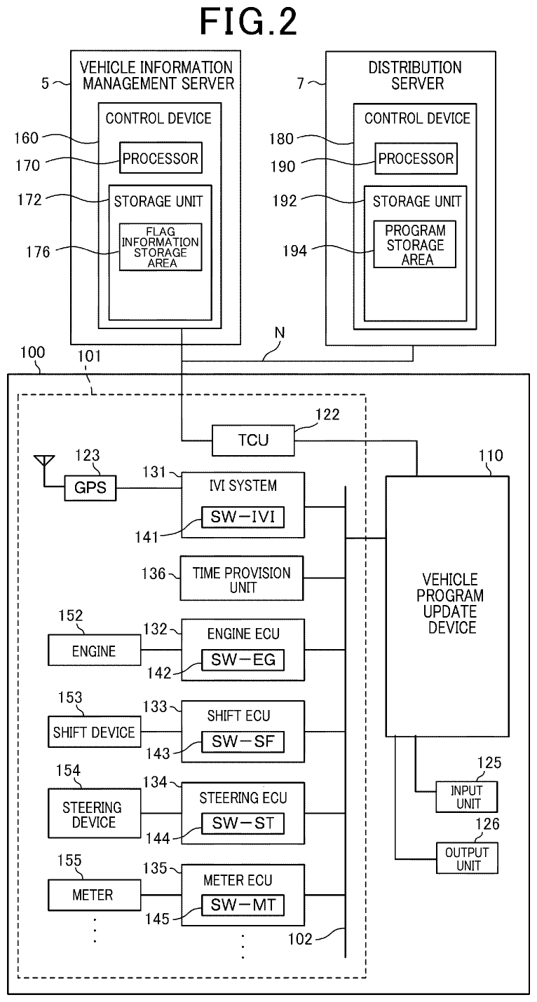

FIG. 2 is a configuration diagram illustrating a configuration of each of the vehicle program update device 110, the vehicle information management server 5, and the distribution server 7 according to the first embodiment.

The vehicle information management server 5 is an information processing device including a control device 160 configured to control the entire vehicle information management server 5. The control device 160 includes a processor 170 configured to perform information processing and a storage unit 172 (memory) configured to store information. The processor 170 is, for example, a central processing unit (CPU), and the storage unit 172 includes a storage medium such as a random access memory (RAM), a read only memory (ROM), a hard disk drive (HDD), or a solid state drive (SSD), for example. The storage unit 172 includes a flag information storage unit 176 configured to store flag information, which will be described later.

The distribution server 7 is an information processing device including a control device 180 configured to control the entire distribution server 7. The control device 180 includes a processor 190 configured to perform information processing and a storage unit 192 (memory) configured to store information.

The processor 190 is, for example a central processing unit (CPU), and the storage unit 192 includes a storage medium such as a random access memory (RAM), a read only memory (ROM), a hard disk drive (HDD), or a solid state drive (SSD), for example. The storage unit 192 includes a program information storage unit 194 configured to store programs to be executed by the vehicle program update device 110 and the vehicle control units (which will be described later), specifically by ECUs to implement various functions.

The vehicle control device 100 includes an on-board device 101, the vehicle program update device 110 configured to manage programs (software) for individual vehicle control units which are information processing devices configured to control respective devices included in the vehicle V, specifically, for the electronic control units (ECUs), and an input unit 125 to which information is to be input, and an output unit 126 from which information is to be output. The input unit 125 may be a touch panel in an on-board in-vehicle infotainment (IVI) system. The output unit 126 may be an image display device (display) included in the IVI or an image display device (display) provided in a meter portion. The output unit 126 may be provided in an instrument panel of a driver's seat, for example. Specifically, the output unit 126 is configured as a so-called multi information display (MID) incorporated in a meter panel. Note that in the present specification, the control device configured to control each device, specifically, the ECU is also referred to as a vehicle control unit.

The on-board device 101 includes a plurality of devices mounted on a vehicle, and a plurality of vehicle control units (ECUs) configured to control the plurality of devices. Specifically, the vehicle control units may include, for example, a telematics control unit (TCU) 122 for performing wireless communication, as one of the vehicle control units. The on-board device 101 of the vehicle V may include an in-vehicle infotainment (IVI) system 131 configured to provide information to an occupant of the vehicle V, an engine ECU 132 configured to control an engine 152, a shift ECU 133 configured to control a shift device 153, a steering ECU 134 configured to control a steering device 154, and a meter ECU 135 configured to control a meter 144. Each ECU includes a processor and a memory, and is connected to the vehicle program update device 110 through a bus 102 to receive and transmit the information. Here, the engine 152 means not only a drive train including an internal combustion engine but also may be a motor electrically driven.

The IVI system 131 implements its function by executing software (program) SW-IVI 141, the engine ECU 132 implements its function by executing software SW-EG 142, the shift ECU 133 implements its function by executing software SW-SF 143, the steering ECU 134 implements its function by executing software SW-ST 144, and the meter ECU 135 implements its function by executing software SW-MT 145. In each software, a program is updated and a function is changed by the vehicle program management system 1 through the wireless communication means WL.

The on-board device 101 includes a time provision unit 136 configured to acquire time information obtained from a global positioning system (GPS) 123 through the IVI system 131, and time information obtained from, for example, the vehicle information management server 5 through the TCU 122 and the network N to provide the acquired information to the vehicle program update device 110, and the like.

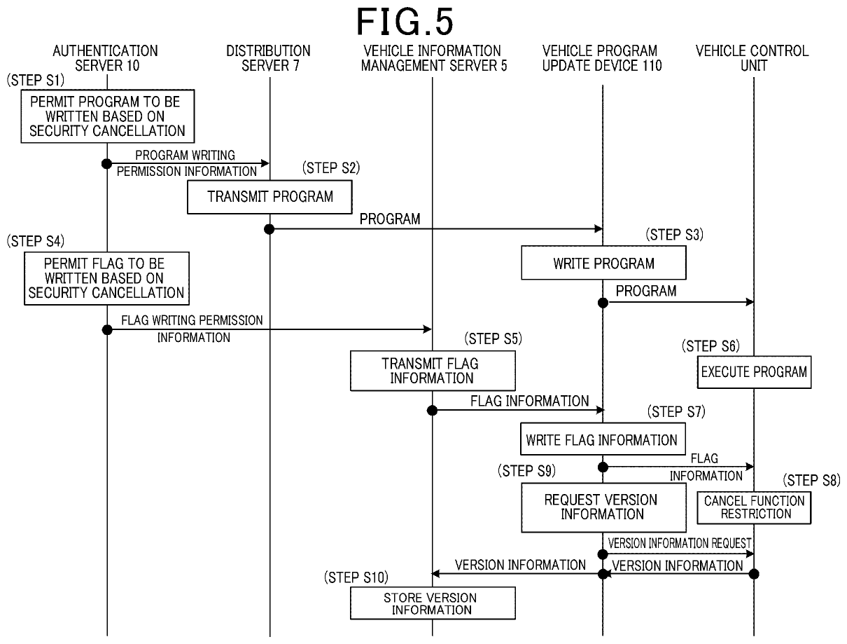

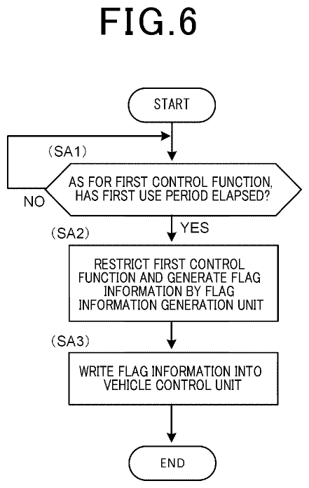

Each ECU is a computer including, specifically, a processor such as a CPU, a ROM to which an execution program has been written, a RAM configured to temporarily store data for controlling a device, a solid state drive (SSD) configured to hold other data, and the like. Specifically, the programs received from the vehicle information management server 5 through the wireless communication means WL are executed by the ECUs which are computers, whereby the devices included in the on-board device 101 are controlled. Instead of or in addition to the above-described ECUs, all or some of the above-described ECUs may be each configured of hardware including one or more electronic circuit components. Operations of the vehicle program update device 110, the vehicle information management server 5 and the like that are included in the vehicle program management system 1 will be described in detail with reference to FIGS. 5, 6 and the like, which will be described later.

Examples of the wireless communication means WL in the present specification, and wireless communication means include wireless communication based on a communication standard such as WiFi (registered trademark), and Bluetooth (registered trademark).

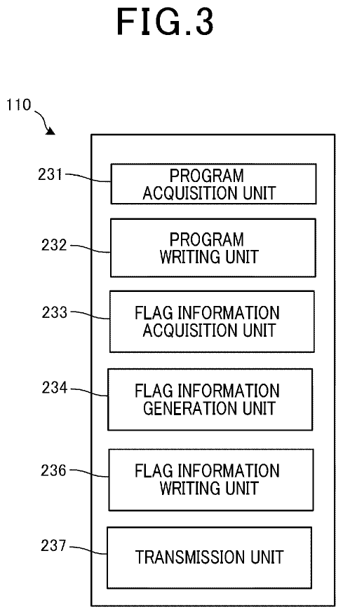

FIG. 3 is a functional block diagram illustrating the vehicle program update device 110. The vehicle program update device 110 is a device that is comprised of a computer, and is connected to the plurality of vehicle control units (ECUs) mounted on the vehicle V to cause a processor to perform information processing for updating a plurality of programs stored in and executed by each of the plurality of vehicle control units, and for changing functions. Specifically, the processor of the vehicle program update device 110 functions as a program acquisition unit 231 configured to acquire a plurality of programs to be installed into each of a plurality of ECUs, from the vehicle information management server 5 which is an external device, a program writing unit 232 configured to install or write the acquired programs into each ECU, a flag information acquisition unit 233 configured to acquire, from the vehicle information management server 5, flag information indicating whether at least one predetermined function of the vehicle is in a usable state, the function being included in a program, among the functions to be implemented by each ECU executing the programs, and a flag information writing unit 236 configured to write the flag information into each ECU. In other words, the flag information writing unit 236 writes the flag information into the program based on instruction information so that a predetermined function of the vehicle control unit is brought into the usable state or a state of function restriction. Here, the instruction information may be information permitting flag information to be written into the program to be executed by a specific vehicle control unit of a specific vehicle V, the flag information being generated by the vehicle information management server 5 based on the authentication of the apparatus authentication server 10. The instruction information may be generated based on the fact that the execution of the predetermined function for the vehicle V has been approved by a manager of the vehicle V. Alternatively, the instruction information may be generated based on the fact that billing processing for the predetermined function has been completed by the manager of the vehicle V.

The vehicle program update device 110 includes a transmission unit 237 configured to transmit, to the vehicle information management server 5, version information about the program installed into the vehicle control unit and at least one piece of the flag information included in the program. The transmission unit 237 transmits, to the vehicle information management server 5, function restriction information which is information about a predetermined function in the state of the function restriction, the predetermined function being included in the program installed into the vehicle control unit.

The vehicle executes a predetermined function which is indicated as usable in the flag information. In other words, a program provided with a predetermined function in advance is installed into each ECU, the predetermined function being brought into the usable state when the flag information is changed.

It is desirable that the flag information acquisition unit 233 acquires the flag information generated based on the fact that the execution of the predetermined function for the vehicle V has been approved by the manager of the vehicle.

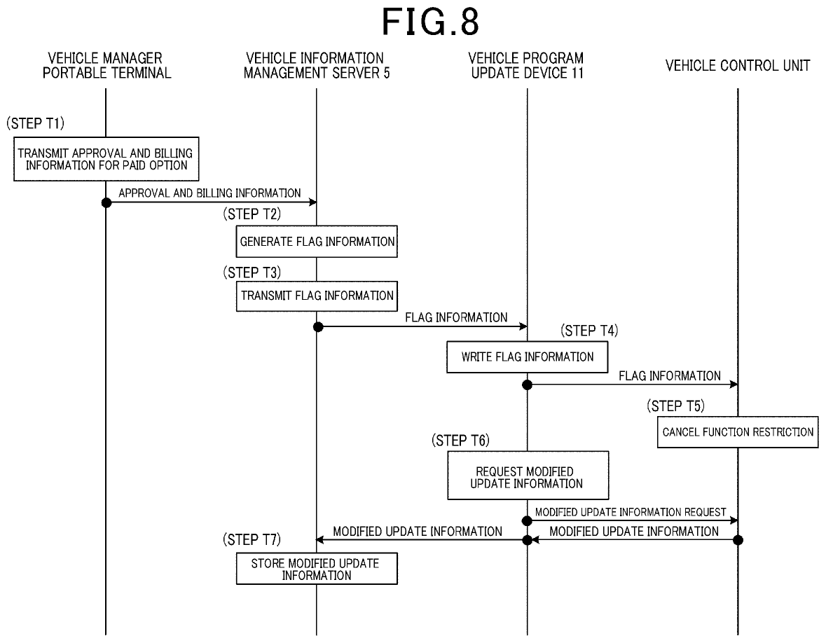

An operation of the flag information acquisition unit 233 based on billing information and approval information by the manager of the vehicle V will be described in detail with reference to FIG. 8, which will be described later.

In the case where a predetermined first function is permitted to be in the usable state during a predetermined first usable period, the vehicle program update device 110 may further include a flag information generation unit 234 configured to generate flag information for bringing the first function into the state of the function restriction after an elapse of the first usable period. An operation of the flag information generation unit 234 will be described in detail with reference to FIG. 6, which will be described later.

Note that the function of the program acquisition unit 231, the function of the program writing unit 232, the function of the flag information acquisition unit 233, the function of the flag information generation unit 234, the function of the flag information writing unit 236, and the function of the transmission unit 237 are implemented by the vehicle program update device 110 executing the program installed into the vehicle program update device 110. Here, for example, even when in an initial state, a program which does not support a function by the flag information is installed, the vehicle program update device 110 may enable an acquisition operation of the flag information, a writing operation of the flag information into each vehicle control unit, and the like by updating the program.

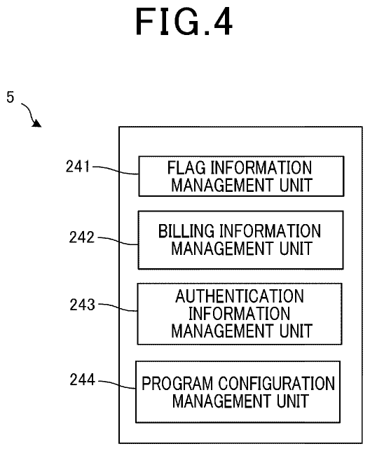

FIG. 4 is a functional block diagram illustrating the vehicle information management server 5. The vehicle information management server 5 includes the processor, and in relation to a plurality of programs causing the processor to execute functions of the respective ECUs included in the vehicle control device 100 in each vehicle V, the processor manages a program configuration which is a combination of the plurality of programs, the flag information, and the programs themselves and the update of the programs. Specifically, the processor of the vehicle information management server 5 manages a version of each program to provide an optimum program configuration for each vehicle V. Note that the program configuration may be associated with a vehicle identification number of each vehicle V. The vehicle information management server 5 includes a program configuration management unit 244 configured to manage a history of a program configuration installed into each ECU in the on-board device 101 to bring the program configuration into a state conforming to the laws.

The vehicle information management server 5 includes a flag information management unit 241 configured to manage the flag information that enables a function of the vehicle control unit to be switchable between the state of the function restriction and the usable state, the function being included in a program, with respect to the vehicle program update device 110 that acquires and manages the program to be installed into a vehicle control unit mounted on the vehicle V through wireless communication means (a transmitter and a receiver), specifically through the wireless communication means WL.

Here, the flag information management unit 241 may manage the flag information based on billing and approval by the manager of the vehicle V. An operation of managing the flag information based on the billing and approval in the vehicle information management server 5 will be described in detail with reference to FIG. 8, which will be described later.

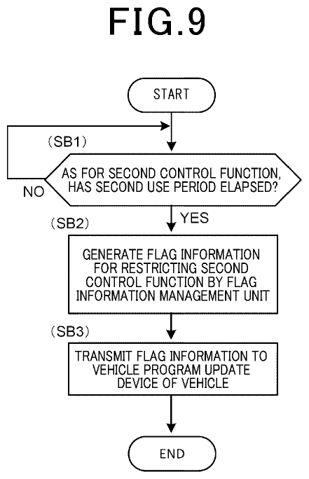

In the case where a predetermined second function is permitted to be in the usable state during a predetermined second usable period, the flag information management unit 241 may generate the flag information for bringing the second function into the state of the function restriction after an elapse of the second usable period. An operation of the flag information management unit 241 will be described in detail with reference to FIG. 9, which will be described later.

The vehicle information management server 5 further includes a billing information management unit 242 configured to manage billing information by the manager of the vehicle V and an authentication information management unit 243 configured to manage authentication information associated with the vehicle V. The billing information management unit 242 and the authentication information management unit 243 implement the functions of the vehicle V based on the states of the billing and the approval, in cooperation with the flag information management unit 241 and the program configuration management unit 244, and the vehicle control device 100, specifically, the vehicle program update device 110 of the vehicle V.

The function of the flag information management unit 241, the function of the billing information management unit 242, the function of the authentication information management unit 243, and the function of the program configuration management unit 244 are implemented by the vehicle information management server 5 executing the program installed into the vehicle information management server 5.

### 1-2. Operations of Vehicle Program Update Device and Vehicle Information Management Server

FIG. 5 is a flowchart illustrating operations to update a program and change a function for each ECU by the vehicle program update device 110 according to the first embodiment, in the vehicle program management system 1.

First, the apparatus authentication server 10 permits a program to be written into the vehicle V based on security cancellation (step S1). Next, the apparatus authentication server 10 transmits program writing permission information to the distribution server 7. The distribution server 7 transmits a program for controlling a vehicle control unit to the vehicle program update device 110 of the target vehicle V (step S2). The program acquisition unit 231 of the vehicle program update device 110 acquires the program from the distribution server 7. Note that the term “program” as used herein may be an update program for updating a control program of each ECU.

The program writing unit 232 of the vehicle program update device 110 writes the program into the target vehicle control unit (ECU) (step S3). For example, when an ignition key is first turned on after the program is written, the vehicle control unit into which the program is written executes the newly written program, and implements control on the device (step S6).

First, the apparatus authentication server 10 permits a flag to be written based on security cancellation of the vehicle V (step S4). Next, the apparatus authentication server 10 transmits flag writing permission information to the vehicle information management server 5, and the flag information management unit 241 of the vehicle information management server 5 acquires the flag writing permission information. Based on the flag writing permission information, the flag information management unit 241 of the vehicle information management server 5 transmits flag information for changing a function of the vehicle control unit, to the vehicle program update device 110 of the target vehicle V (step S5). The flag information acquisition unit 233 of the vehicle program update device 110 acquires the flag information from the vehicle information management server 5.

The flag information writing unit 236 of the vehicle program update device 110 writes the flag information into the target vehicle control unit (ECU) (step S7).

For example, when the ignition key is first turned on after the flag information is written, the vehicle control unit into which the program is written changes the function based on the newly written flag information, and executes the program, whereby a predetermined function restriction is canceled to implement new function of the device (step S8). The apparatus authentication server 10 requests version information of the program to the vehicle control unit. Then, the vehicle control unit transmits the version information to the apparatus authentication server 10, and the vehicle program update device 110 transmits the version information to the vehicle information management server 5. The vehicle information management server 5 stores the version information (step S10).

FIG. 6 is a flowchart of a flag information generation operation in the vehicle program update device 110. The vehicle program update device 110 acquires time information from the time provision unit 136, and determines whether a first use period has elapsed, the first use period being a usable period in relation to a predetermined first function for a predetermined ECU (step SA1). Specifically, the vehicle program update device 110 has a timer function, and determines whether the first use period has elapsed from the date and time when the first function becomes usable. When the first use period has not elapsed (step SA1: NO), the processing returns to START. When the first use period has elapsed (step SA1: YES), the flag information generation unit 234 of the vehicle program update device 110 generates the flag information for bringing the first function into the state of the function restriction (step SA2), and the flag information writing unit 236 writes, into the target vehicle control unit, the flag information for performing the function restriction (step SA3).

The first use period may be, for example, one week.

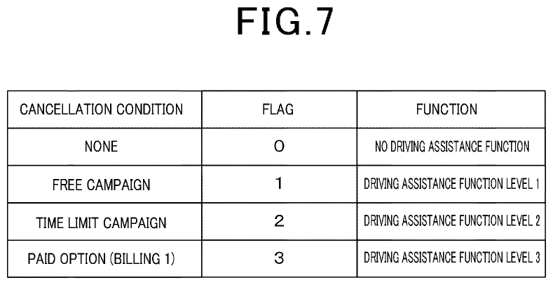

FIG. 7 is a table illustrating an example of correspondence between a function change and flag information based on billing or the like. The SW-SF143 is exemplified which implements the function of the shift ECU 133 to control the shift device 153. Specifically, in the initial state, 0 is written, as the flag information, into the SW-SF143, no driving assistance function is provided. On the other hand, in the case where a free campaign is performed to add a driving assistance function level 1, “1” is written, as the flag information, into the SW-SF143, and a function corresponding to the driving assistance function level 1 becomes usable. For example, in the case where a time limit campaign is performed to restrict the use period during which a new function can be experienced so that a driving assistance function level 2 can be experienced at which a shift action providing sporty driving experience is performed, “2” is written, as the flag information, into the SW-SF143, and a function corresponding to the driving assistance function level 2 becomes usable.

At this time, in the case where a trial period of one month for the driving assistance function level 2 is set as the first usable period, when the first use period has elapsed, the vehicle program update device 110 writes “0” as the flag information into SW-SF143 and returns to the state in which no driving assistance function is provided.

Note that in the present embodiment, the flag information is generated by the vehicle program update device 110, but an aspect may be adopted in which the vehicle information management server 5 generates the flag information. Such an aspect will be described in a third embodiment, which will be described later.

FIG. 8 is a flowchart illustrating an operation of changing a function based on the approval information and billing information of the manager of the vehicle V. For example, it is assumed that the manager of the vehicle V has concluded a subscription contract enabling a function included in paid options to be always added. It is assumed that in the case where service is provided enabling a new function to be used during the contract period, approval information for approving addition of a function included in the paid options is transmitted from a portable terminal of the vehicle manager (step T1). At this time, the billing information indicating that the vehicle manager has paid the monthly usage fee based on the subscription contract may be transmitted to the vehicle information management server 5. To determine as to whether to be transmitted from the vehicle manager, it is also conceivable that the apparatus authentication server 10 verifies the correspondence between the vehicle identification number associated with the vehicle V and the portable terminal of the vehicle manager. The verification result by the apparatus authentication server 10 may be transmitted to the authentication information management unit 243 of the vehicle information management server 5, so that the authentication information management unit 243 determines whether to proceed with function cancellation processing. The billing information management unit 242 of the vehicle information management server 5 may determine whether to proceed with the function cancellation processing, based on the billing information.

The vehicle information management server 5 that has acquired the approval information and the billing information generates flag information for bringing a function of the vehicle control unit into the usable state, the function being subject to the paid options (step T2), and transmits the flag information to the vehicle program update device 110 (step T3). The vehicle program update device 110 that has acquired the flag information writes the flag information into the target vehicle control unit (step T4). Then, the vehicle control unit in which the flag information is written into the program cancels the function restriction of a function which becomes usable, and brings the function into the usable state (step T5). The vehicle program update device 110 requests the version information of the program to the vehicle control unit (step T6), and the vehicle control unit transmits the version information to the vehicle program update device 110. Specifically, the flag information written into the program for each ECU is acquired as the version information, and is transmitted to the vehicle program update device 110. The vehicle program update device 110 transmits the version information to the vehicle information management server 5, and the vehicle information management server 5 stores the version information (step T7).

Returning to FIG. 7, an operation of FIG. 8 will be further described. It is assumed that as the paid options, a driving assistance function level 3 is set at which the shift action enabling improvement in fuel consumption is performed, for example. In the case where the apparatus authentication server 10 receives information that the manager of the vehicle V has performed billing 1 included in the paid options, the apparatus authentication server 10 transmits flag information writing permission information to the vehicle information management server 5. Then, according to the flow illustrated in FIG. 5, the vehicle program update device 110 writes “3” as the flag information into the SW-SF143, and the shift device 153 controlled by the shift ECU 133 implements the function included in the driving assistance function level 3.

### 2-1. Configuration of Vehicle According to Second Embodiment

A vehicle according to a second embodiment is a vehicle including the vehicle program update device 110 according to the first embodiment. A physical configuration of a vehicle program update device 110 is similar to a configuration of the vehicle program update device 110 according to the first embodiment, and hence detailed description is omitted (see FIG. 2). Functions of the vehicle program update device 110 are similar to the functional block illustrated in FIG. 3, and hence detailed description is omitted.

### 2-2. Operations of Vehicle According to Second Embodiment

Operations of the vehicle according to the second embodiment are similar to operations (see FIGS. 5 and 6) of the vehicle program update device 110 according to the first embodiment, and hence detailed description is omitted.

### 3-1. Configuration of Vehicle Information Management Server According to Third Embodiment

A configuration of a vehicle information management server according to a third embodiment is similar to a configuration of the vehicle information management server 5 illustrated in FIG. 2, and hence detailed description is omitted.

### 3-2. Operations of Vehicle Information Management Server According to Third Embodiment

Operations of the vehicle information management server according to the third embodiment will be described focusing on different portions from the operations of the vehicle information management server 5 illustrated in FIGS. 5 and 8.

FIG. 9 is a flowchart illustrating operations for changing a function by the vehicle information management server 5. A flag information management unit 241 of the vehicle information management server 5 determines whether a second use period of a second function has elapsed in relation to the second function for the vehicle V (step SB1). Specifically, the flag information management unit 241 has a timer function, and determines whether the second use period has elapsed from the date and time when the second function becomes usable. When the second use period has not elapsed (step SB1: NO), the processing returns to START. When the second use period has elapsed (step SB1: YES), the flag information management unit 241 of the vehicle information management server 5 generates the flag information for performing function restriction of the second function (step SB2), and the flag information writing unit 236 writes, into the target vehicle control unit, the flag information for performing the function restriction (step SB3).

The second use period may be, for example, one week.

Note that in the vehicle information management server 5, the flag information management unit 241 may generate flag information in cooperation with the billing information management unit 242 and the authentication information management unit 243, and distribute the flag information to the target vehicle. Specifically, for example, in the case where the vehicle manager fails to pay the monthly usage fee against the subscription contract, the billing information management unit 242 acquires such information, and the flag information management unit 241 generates flag information for returning the function as a target of the contract from the usable state to the state of the function restriction, and distributes the flag information to the vehicle program update device 110 of the target vehicle to restrict the function.

### 4. Configurations of Program Update Method According to Fourth Embodiment

A program update method according to a fourth embodiment includes a program acquisition step of acquiring a program to be installed into a vehicle control unit mounted on a vehicle from a distribution server through wireless communication means, a program writing step of performing writing processing of the program acquired in the program acquisition step into the vehicle control unit, a flag information acquisition step of acquiring flag information indicating whether at least one predetermined function of the vehicle is in a usable state, the function being included in the program, from the program processed in the program writing step, a flag information writing step of writing the flag information into the program so that the flag information indicates the usable state or a state of function restriction based on instruction information, and a transmission step of transmitting, to a vehicle information management server, version information about the program installed into the vehicle control unit and at least one piece of the flag information included in the program, in which the vehicle executes the predetermined function which is indicated as usable in the flag information.

The flag information acquisition step may acquire the flag information generated based on the fact that the execution of the predetermined function for the vehicle has been approved by the manager of the vehicle.

### 5. Other Embodiments

In the above-described embodiments, an aspect has been described in which the vehicle manager transmits the approval information for adding a function included in the paid options from the portable terminal of the vehicle manager, but the approval information and the like may be input from the input unit 125 of the vehicle V without using the portable terminal.

In the above-described embodiments, an aspect has been described in which the function restriction is performed after the usable period has elapsed, but if the communication between the vehicle and the vehicle information management server 5 is cut off for a certain period or longer, the function in the usable state may be restricted again.

### 6. Configurations Supported by Above-Described Embodiments

The above-described embodiments support the following configurations.

(Configuration 1) A vehicle program update device 110 including a program acquisition unit 231 configured to acquire a program to be installed into a vehicle control unit mounted on a vehicle V from a distribution server 7 through wireless communication means WL, a program writing unit 232 configured to perform writing processing of the program acquired by the program acquisition unit 231 into the vehicle control unit, a flag information acquisition unit 233 configured to acquire flag information indicating whether at least one predetermined function of the vehicle V is in a usable state, the function being included in the program, from the program processed by the program writing unit 232, a flag information writing unit 236 configured to write the flag information into the program so that the flag information indicates the usable state or a state of function restriction based on instruction information, and a transmission unit 237 configured to transmit, to a vehicle information management server 5, version information about the program installed into the vehicle control unit and at least one piece of the flag information included in the program, wherein the vehicle V executes the predetermined function which is indicated as usable in the flag information.

According to the vehicle program update device of configuration 1, the function can be added or eliminated by writing the flag information without changing the version of the program to be installed into the control device for controlling the device mounted on the vehicle. This produces an advantageous effect that both of the update management for the program and flexible operation of the function can be achieved according to the laws and regulations.

(Configuration 2) The vehicle program update device according to configuration 1, wherein the transmission unit 237 transmits, to the vehicle information management server 5, function restriction information which is information about the predetermined function in the state of the function restriction, the predetermined function being included in the program installed into the vehicle control unit.

According to the vehicle program update device of configuration 2, those that maintain the vehicle can manage which function is restricted for each vehicle. This produces an advantageous effect that illegal function release and degradation in security can be prevented.

(Configuration 3) The vehicle program update device according to configuration 1 or 2, wherein the instruction information is generated based on a fact that execution of the predetermined function for the vehicle has been approved by a manager of the vehicle V, and the flag information writing unit 236 writes the flag information into the program based on the instruction information.

The vehicle program update device of configuration 3 makes it possible to acquire the flag information generated based on a fact that execution of the predetermined function for the vehicle has been approved by a manager of the vehicle and write the flag information into the vehicle control unit, whereby those that performs the maintenance can distribute the information for changing the function to the target vehicle using the action of the manager of the vehicle as a trigger. This produces an advantageous effect that the function can be flexibly changed.

(Configuration 4) The vehicle program update device according to configuration 1 or 2, wherein the instruction information is generated based on a fact that billing processing for the predetermined function has been completed by a manager of the vehicle, and the flag information writing unit 236 writes the flag information into the program based on the instruction information.

The vehicle program update device of configuration 4 produces an advantageous effect that the function can be flexibly changed according to the billing by the manager of the vehicle.

(Configuration 5) The vehicle program update device according to any one of configurations 1 to 4, further including a flag information generation unit 234 configured to generate the flag information for bringing a predetermined first function into the state of the function restriction after an elapse of a first usable period in a case where the first function is permitted to be in the usable state during the first usable period.

A malicious attempt is conceivable to intentionally disturb communication by OTA to perpetuate the upgrade of the function distributed based on time limit campaign. According to the vehicle program update device of configuration 5, the vehicle program update device itself can generate the flag information for performing the function restriction and restrict the function after an elapse of the predetermined use period. This produces an advantageous effect that the illegal change in the function can be prevented.

(Configuration 6) A vehicle on which the vehicle program update device 110 according to any one of configurations 1 to 5 is mounted.

According to the vehicle of configuration 6, the function can be added or eliminated by writing the flag information into the program without changing the version of the program to be installed into the control device for controlling the device mounted on the vehicle. This produces an advantageous effect that both of the update management for the program and flexible operation of the function can be achieved according to the laws and regulations.

(Configuration 7) A vehicle information management server 5 that manages a vehicle V, the server including a flag information management unit 241 configured to manage flag information indicating that at least one predetermined function of the vehicle is in a usable state, among functions included in a program for a vehicle control unit, with respect to a vehicle program update device 110 that acquires and manages the program to be installed into the vehicle control unit mounted on the vehicle V through wireless communication means WL.

According to the vehicle of configuration 7, the function can be added or eliminated by managing the flag information without changing the version of the program to be installed into the control device for controlling the device mounted on the vehicle. This produces an advantageous effect that both of the update management for the program and flexible operation of the function can be achieved according to the laws and regulations.

(Configuration 8) The vehicle information management server according to configuration 7, wherein the flag information management unit 241 manages the flag information based on a fact that execution of the predetermined function for the vehicle has been approved by a manager of the vehicle V.

The vehicle information management server of configuration 8 makes it possible to manage the flag information generated based on a fact that execution of the predetermined function for the vehicle has been approved by a manager of the vehicle, whereby those that performs the maintenance can distribute the information for changing the function to the target vehicle using the action of the manager of the vehicle as a trigger. This produces an advantageous effect that the function can be flexibly changed.

(Configuration 9) The vehicle information management server according to configurations 7 or 8, wherein the flag information management unit 241 generates the flag information for bringing a predetermined second function into the state of the function restriction after an elapse of a predetermined second usable period in a case where the second function is permitted to be in the usable state during the second usable period.

According to the vehicle information management server of configuration 9, the flag information enabling the function of the vehicle to be changed can be managed by the vehicle information management server, whereby a campaign to try the function change can be performed at the same time with respect to a plurality of target vehicles currently on the market, for a certain period. This produces an advantageous effect that the business associated with the function change can be smoothly conducted.

(Configuration 10) A program update method including a program acquisition step of acquiring a program to be installed into a vehicle control unit mounted on a vehicle from a distribution server 7 through wireless communication means WL, a program writing step of performing writing processing of the program acquired in the program acquisition step into the vehicle control unit, a flag information acquisition step of acquiring flag information indicating whether at least one predetermined function of the vehicle is in a usable state, the function being included in the program, from the program processed in the program writing step, a flag information writing step of writing the flag information into the program so that the flag information indicates the usable state or a state of function restriction based on instruction information, and a transmission step of transmitting, to a vehicle information management server, version information about the program installed into the vehicle control unit and at least one piece of the flag information included in the program, wherein the vehicle executes the predetermined function which is indicated as usable in the flag information.

According to the program update method of configuration 10, the function can be added or eliminated by writing the flag information into the program without changing the version of the program to be installed into the control device for controlling the device mounted on the vehicle. This produces an advantageous effect that both of the update management for the program and flexible operation of the function can be achieved according to the laws and regulations.

(Configuration 11) The program update method according to configuration 10, wherein the flag information acquisition step acquires the flag information generated based on a fact that execution of the predetermined function for the vehicle has been approved by a manager of the vehicle.

According to the program update method of configuration 11 makes it possible to acquire the flag information generated based on a fact that execution of the predetermined function for the vehicle has been approved by a manager of the vehicle and write the flag information into the vehicle control unit, whereby those that performs the maintenance can distribute the information for changing the function to the target vehicle using the action of the manager of the vehicle as a trigger. This produces an advantageous effect that the function can be flexibly changed according to billing, for example.

The first to fourth embodiments have been described as exemplifications of the techniques disclosed in the present application. However, the techniques in the present disclosure are not limited thereto, and are also applicable to embodiments in which modifications, replacements, additions, omissions and the like are made. Additionally, the constituent elements described in the above-described embodiments can be combined to provide a new embodiment.

For example, step units of operations illustrated in FIGS. 5, 6, 8, and 9 are classified according to main processing contents to facilitate the understanding of operations of the vehicle information management server 5 and the vehicle program update device 110 that are included in the vehicle program management system 1, and the present invention is never limited by the way how to divide the processing units or the names.

The step units of operation may be divided into still more step units according to the processing contents.
The step units of operation may be divided such that one step unit includes still more processes. The order of steps may be switched around as appropriate without departing from the sprit and scope of the present invention.

### REFERENCE SIGNS LIST

1 . . . Vehicle program management system, 5 . . . Vehicle information management server, 7 . . . Distribution server, 10 . . . Apparatus authentication server, 100 . . . Vehicle control unit, 101 . . . On-board device, 102 . . . Bus, 110 . . . Vehicle program update device, 122 . . . TCU, 125 . . . Input unit, 126 . . . Output unit, 131 . . . IVI system, 133 . . . Shift ECU, 134 . . . Steering ECU, 135, Meter ECU, 136 . . . Time provision unit, 141 . . . SW-IVI, 142 . . . SW-EG, 143 . . . SW-SF, 144 . . . SW-ST, 145 . . . SW-MT, 152 . . . Engine, 153 . . . shift device, 154 . . . Steering device, 155 . . . Meter, 160 . . . Control device, 170 . . . Processor, 172 . . . Storage unit, 176 . . . Flag information storage area, 180 . . . Control device, 190 . . . Processor, 192 . . . Storage unit, 194 . . . Program storage area, 231 . . . Program acquisition unit, 232 . . . Program writing unit, 233 . . . Flag information acquisition unit, 234 . . . Flag information generation unit, 236 . . . Flag information writing unit, 237 . . . Transmission unit, 241 . . . Flag information management unit, 242 . . . Billing information management unit, 243 . . . Authentication information management unit, 244 . . . Program configuration management unit, B . . . Base station, V . . . Vehicle, N . . . Communication network, WL . . . Wireless communication means

What is claimed is:

1. A vehicle program update device, comprising a processor and a memory which are mounted on a vehicle,
wherein the processor
acquires a program to be recorded in the memory from a distribution server through wireless communication means,
performs writing processing of the acquired program into the memory,
acquires flag information indicating whether at least one predetermined function of the vehicle is in a usable state, the function being included in the program, from the program subjected to the writing processing,
writes the flag information into the program so that the flag information indicates the usable state or a state of function restriction based on instruction information, and
transmits, to a vehicle information management server, version information about the program recorded in the memory and at least one piece of the flag information included in the program, and
the vehicle executes the predetermined function which is indicated as usable in the flag information.

2. The vehicle program update device according to claim 1, wherein
the processor
transmits, to the vehicle information management server, function restriction information which is information about the predetermined function in the state of the function restriction, the predetermined function being included in the program recorded in the memory.

3. The vehicle program update device according to claim 1, wherein
the instruction information is generated based on a fact that execution of the predetermined function for the vehicle has been approved by a manager of the vehicle, and the processor writes the flag information into the program based on the instruction information.

4. The vehicle program update device according to claim 1, wherein
the instruction information is generated based on a fact that billing processing for the predetermined function has been completed by a manager of the vehicle, and
the processor writes the flag information into the program based on the instruction information.

5. The vehicle program update device according to claim 1, wherein
the processor
generates the flag information for bringing a predetermined first function into the state of the function restriction after an elapse of a first usable period in a case where the first function is permitted to be in the usable state during the first usable period.

6. A vehicle on which the vehicle program update device according to claim 1 is mounted.

7. A vehicle information management server, comprising a management server processor configured to manage a vehicle,
wherein the management server processor
manages flag information indicating that at least one predetermined function of the vehicle is in a usable state, among functions included in a program for a vehicle control unit, with respect to a vehicle program update device that acquires and manages the program to be executed by a processor mounted on the vehicle through wireless communication means.

8. The vehicle information management server according to claim 7, wherein
the management server processor
manages the flag information based on a fact that execution of the predetermined function for the vehicle has been approved by a manager of the vehicle.

9. The vehicle information management server according to claim 7, wherein
the management server processor
generates the flag information for bringing a predetermined second function into the state of the function restriction after an elapse of a predetermined second usable period in a case where the second function is permitted to be in the usable state during the second usable period.

10. A program update method, comprising:
a program acquisition step of acquiring a program to be executed by a processor mounted on a vehicle from a distribution server through wireless communication means;
a program writing step of performing writing processing of the acquired program into memory mounted on the vehicle;
a flag information acquisition step of acquiring flag information indicating whether at least one predetermined function of the vehicle is in a usable state, the function being included in the program, from the program processed in the program writing step;
a flag information writing step of writing the flag information into the program so that the flag information indicates the usable state or a state of function restriction based on instruction information; and
a transmission step of transmitting, to a vehicle information management server, version information about the program recorded in the memory and at least one piece of the flag information included in the program,
wherein the vehicle executes the predetermined function which is indicated as usable in the flag information.

11. The program update method according to claim 10, wherein
the flag information acquisition step acquires the flag information generated based on a fact that execution of the predetermined function for the vehicle has been approved by a manager of the vehicle.
